(19) United States
(12) Patent Application Publication
(10) Pub. No.: US 2004/0068898 A1
(43) Pub. Date: Apr. 15, 2004

(54) Coin display and preservation device

(75) Inventor: James J. Macor, Jackson, NJ (US)

Correspondence Address: Richard J. Macor, Proprietary Techologies, Inc., 26 Alpaugh Drive, Asbury, NJ, 08802-1213, US

(73) Assignee: Proprietary Technologies, Inc.

(21) Appl. No.: 10/271,216

(22) Filed: Oct. 15, 2002

(51) Int. Cl. G09F 3/02

(52) U.S. Cl. 40/27.5

(57) ABSTRACT

A device for the display and preservation of a coin is described, the device comprises a coin housing and a display board. The coin housing comprises at least two, substantially transparent interconnecting members formed to house a coin therein with a substantially air-tight encapsulation. The coin housing further has a periphery formed with at least a portion thereof having a flange. The periphery has predetermined outer dimensions. The display board has a cavity formed therein and the cavity is formed through the display board having a periphery formed to accommodate the periphery of the coin housing to receive and secure the coin housing therein. The flange is further formed so as to prevent the coin housing from being pushed fully through the cavity of the display board. In other embodiments, the periphery of the coin housing may, or may not have a flange, and, at least a small portion of the periphery of the cavity may, or may not have a step formed so as to prevent the coin housing from being pushed fully through the cavity of the display board. In the same or other embodiments, there may be two or more coin housings and two or more cavities formed in at least one display board, to accommodate the display and preservation of two or more coins.

### FIELD OF THE INVENTION

The present invention relates to a display and preservation device for use with a coin, or a group of coins.

### BACKGROUND OF THE INVENTION

Over time, there have been a number of coin display and storage devices available to coin collectors and numismatists. For example, the “Whitman” brand coin albums have been used for decades by coin collectors seeking to display and store a group or series of coins. Often, these coin series include full date sets of a coin denomination, such as Lincoln pennies. The “Whitman” brand coin albums provide for the display of coins, usually sequentially by date and mintmark, and the coins may be added one at a time until the series is complete, and the album is full. This brand of coin display and storage devices or coin albums, is available in basically two types. The first type of album utilizes thick cardboard pages which have circular cut-outs sized to the height and diameter of the coins being displayed and stored. A coin is carefully pushed into a cut-out so as to not push it fully through the cut-out, or tilt and misalign the coin relative to the cut-out. The coin is held in place by acute friction between the coin edge (reeding surface) and the circumference of the circular cut-out. The second type of album is similar to the first type described above, but also includes a clear acetate type panel that slides over the obverse and reverse of the coins to provide an added level of protection for the displayed coins. These two types of coin albums or display and storage devices have been utilized for decades.

To a serious numismatist who is serious about the display and preservation of coins, the two types of coin albums described above have several faults. These faults relate to the methods necessary for the installation of the coin within the album, and, the transparent sliding acetate type panels. A mint state and/or uncirculated coin has pristine surfaces that can be adversely affected by the handling process of pressing the coin into the cut-out of an album page. In addition, the cardboard type pages may leach out chemicals (i.e. sulfurs) that are harmful especially to copper, nickel and/or silver coins, over time. In addition, the sliding acetate type panels designed to protect the coins may actually damage the coins. The action of sliding panels over the surfaces of the coins can create surface scratches and/or rub marks, which may reduce the value of the coins. Accordingly, there is a need for a better device to both display and effectively preserve a coin, or group of coins.

### SUMMARY OF THE INVENTION

A device for the display and preservation of a coin is described, the device comprises a coin housing and a display board. The coin housing comprises at least two, substantially transparent interconnecting members formed to house a coin therein with a substantially air-tight encapsulation. The coin housing further has a periphery formed with at least a portion thereof having a flange. The periphery has predetermined outer dimensions. The display board has a cavity formed therein and the cavity is formed through the display board having a periphery formed to accommodate the periphery of the coin housing to receive and secure the coin housing therein. The coin housing flange is further formed so as to prevent the coin housing from being pushed fully through the cavity of the display board. In other embodiments, the periphery of the coin housing may, or may not have a flange, and, at least a small portion of the periphery of the cavity may, or may not have a step formed so as to prevent the coin housing from being pushed fully through the cavity of the display board. In the same or other embodiments, there may be two or more coin housings and two or more cavities formed in at least one display board, to accommodate the display and preservation of two or more coins.

Recognizing the need to develop a better device to both display and effectively preserve a coin or group of coins, the following objectives are considered.

An important objective of the present invention is that it provide effective, long term preservation of a coin, or group of coins.

Another important objective of the present invention device is that the obverse and reverse surfaces of each coin are fully displayed and viewable.

Another important objective of the present invention device is that each coin be housed in a coin housing that is easily and effectively secured to a display board for the display and preservation of each coin.

Another important objective of the present invention device is that the procedural installation of a coin does not require pressing directly upon the obverse or reverse surfaces of the coin.

Another objective of the present invention device is that the device does not include sliding panels which could rub against the surfaces of the coin.

Another important objective of the present invention device is that the each coin housing is made from an inert, synthetic material that will not chemically affect a housed coin.

Another important objective of the present invention device is that it be commercially viable, simple in design and cost efficient to manufacture.

### BRIEF DESCRIPTION OF THE DRAWINGS

FIG. 1 shows a side elevational view of a present invention coin housing embodiment and a coin prior to the coin being installed within the coin housing.

FIG. 2 shows a side elevational view of the coin housing components and coin shown in FIG. 1 with the coin installed within the coin housing.

FIG. 3 shows a perspective view of an embodiment of a present invention device comprising a coin housing, display board and coin prior to the coin being installed within the coin housing.

FIG. 4 shows a perspective view of another embodiment of a present invention device comprising a coin housing, display board and coin prior to the coin being installed within the coin housing.

FIG. 5 shows a perspective view of another possible embodiment of a present invention device comprising a coin housing, display board and coin prior to the coin being installed within the coin housing.

### DETAILED DESCRIPTION OF THE DRAWINGS

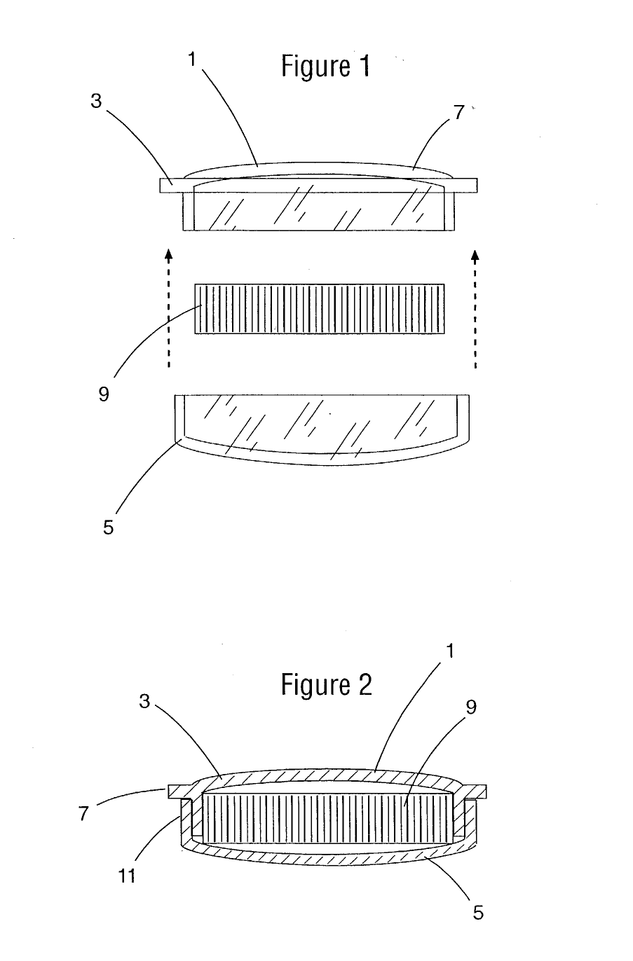

Referring now to the drawings which are for the purpose of illustrating preferred embodiments of the present invention and not for the purpose of limiting same, FIG. 1 shows a side elevational view of a present invention coin housing embodiment and a coin, prior to the coin being installed within the coin housing. Coin housing 1 comprises two, substantially transparent interconnecting members 5 and 7. Coin housing 1 is formed to house coin 9 therein with a substantially air-tight encapsulation. In preferred embodiments, coin housing 1 would be made from an inert synthetic material so that coin housing 1 would not chemically affect coin 9, over time. Preferred embodiments of the coin housing may, or may not, have a flange 3 as shown.

FIG. 2 shows a side elevational view of the coin housing components and coin shown in FIG. 1, with the coin 9 installed within the coin housing 1. The coin housing halves are assembled together as shown after the coin is placed therein. Unlike the prior art albums described earlier herein, the present invention coin housing does not require one to press down on the surfaces of the coin to facilitate installation thereof.

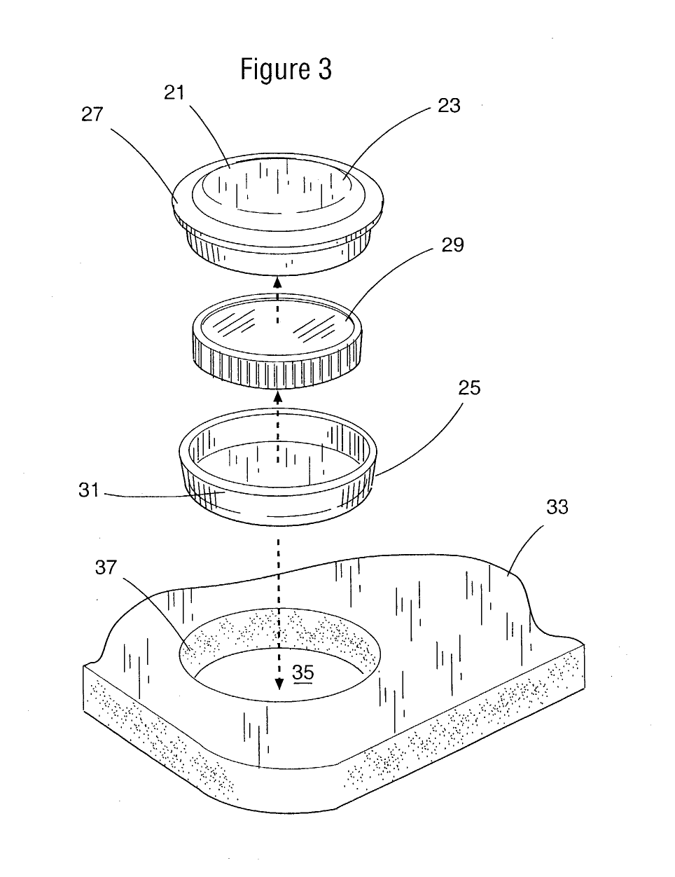

FIG. 3 shows a perspective view of an embodiment of a present invention device comprising a coin housing 21, display board 33 and coin 29 prior to the coin being installed within the coin housing. In this embodiment, coin housing 21 comprises two, substantially transparent interconnecting members 23 and 25 formed to house coin 29 therein with a substantially air-tight encapsulation. Coin housing 21 has two interconnecting members, however, other embodiments may comprise more than two interconnecting members. In this embodiment, coin housing 21 has a periphery formed with at least a portion thereof having a flange 27. Periphery 31 and flange 27 of coin housing 21 each have predetermined outer dimensions. Display board 33 is shown having cavity 35 formed therein through display board 33. Cavity 35 has a periphery 37 formed to accommodate the periphery 31 of coin housing 21 to receive and secure coin housing 21 therein. Flange 27 of coin housing 21 is further formed so as to prevent coin housing 21 from being pushed fully through cavity 35 of display board 33. Another benefit of flange 27 is that it acts to seat and align coin housing 21 relative to display board 33. In this embodiment of the present invention shown, periphery 31 and periphery 37 are each formed so as to frictionally secure coin housing 21 within cavity 35 of display board 33. Periphery 31 of coin housing 21 may be slightly tapered so as to facilitate installation of coin housing 21 into cavity 35. Other embodiments of the present invention may include a device wherein periphery 31 and periphery 37 are each formed with interlocking means so as to materially secure coin housing 21 within cavity 35 of display board 33. For example, periphery 31 of coin housing 21 may have a protrusion or protrusions formed to interlock with a corresponding cavity or corresponding cavities located on periphery 37 of cavity 35. The present invention device shown will accommodate one coin, however, two or more coins, or a group of coins may be displayed and preserved using additional coin housings and display board cavities. This novel configuration of the present invention device achieves all the objectives set forth earlier herein including the long term display and preservation of a coin, or a group of coins.

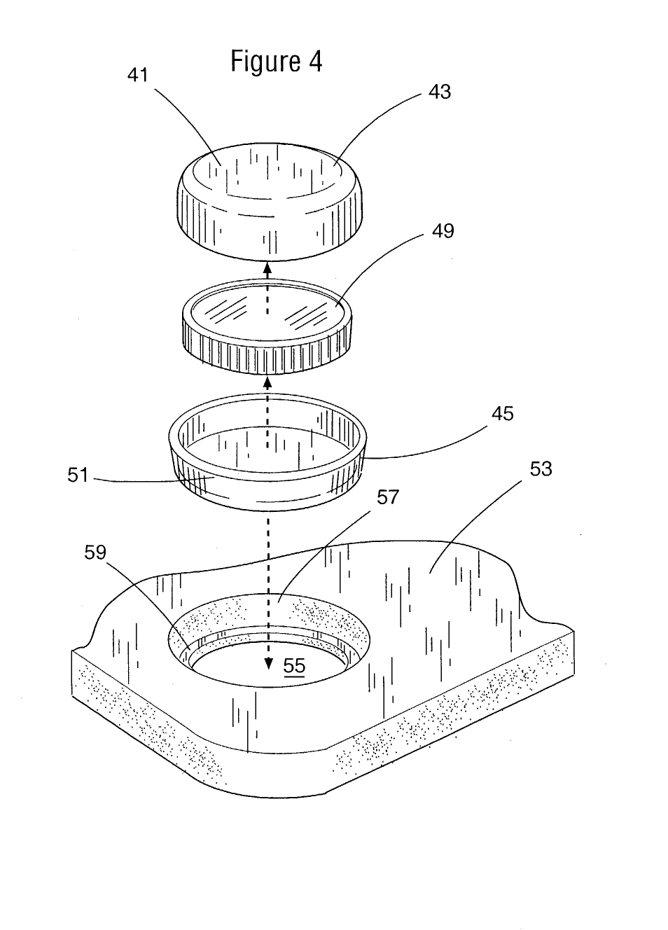

FIG. 4 shows a perspective view of another embodiment of a present invention device comprising a coin housing 41, display board 53 and coin 49 prior to the coin being installed within the coin housing. Coin housing 41 comprises two, substantially transparent interconnecting members 43 and 45 formed to house coin 49 therein with a substantially air-tight encapsulation. The coin housing has two interconnecting members, however, other embodiments may comprise more than two interconnecting members. Periphery 51 of coin housing member 45 is formed with predetermined outer dimensions. Display board 53 is shown having cavity 55 formed therein through display board 53. Cavity 55 has a periphery 57 formed to accommodate periphery 51 of coin housing 41, to receive and secure coin housing 41 therein. At least a small portion of periphery 57of cavity 55 has a step 59 formed, so as to prevent coin housing 41 from being pushed fully through cavity 55 of display board 53. Another benefit of step 59 is that it acts to seat and align coin housing 41 relative to display board 53. In this embodiment of the present invention shown, periphery 51 and periphery 57 are each formed so as to frictionally secure coin housing 41 within cavity 55 of display board 53. Periphery 51 of coin housing 41 may be slightly tapered so as to facilitate installation of coin housing 41 into cavity 55. Other embodiments of the present invention may include a device wherein periphery 51 and periphery 57 are each formed with interlocking means so as to materially secure coin housing 41 within cavity 55 of display board 53. For example, periphery 51 of coin housing 41 may have a protrusion or protrusions formed to interlock with a corresponding cavity or corresponding cavities located on periphery 57 of cavity 55. The present invention device shown will accommodate one coin, however, two or more coins, or a group of coins may be displayed and preserved using additional coin housings and display board cavities. This novel configuration of the present invention device achieves all the objectives set forth earlier herein including the long term display and preservation of a coin, or a group of coins.

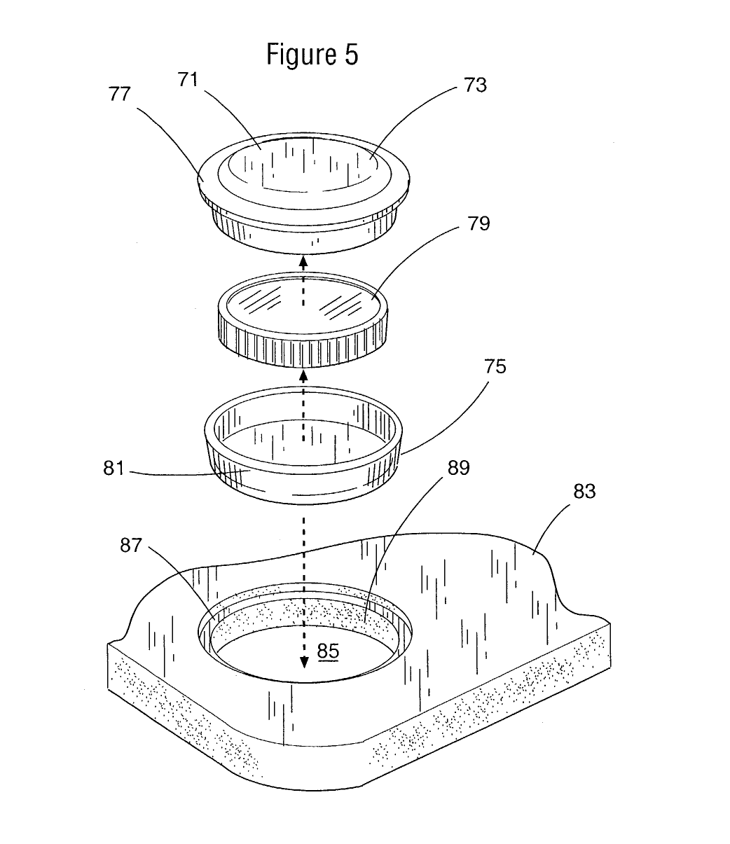

FIG. 5 shows a perspective view of another possible embodiment of a present invention device comprising a coin housing 71, display board 83 and coin 79 prior to the coin being installed within the coin housing. In this embodiment, coin housing 71 comprises two, substantially transparent interconnecting members 73 and 75 formed to house coin 79 therein with a substantially air-tight encapsulation. Coin housing 71 has two interconnecting members, however, other embodiments may comprise more than two interconnecting members. In this embodiment of the present invention, coin housing 71 has a periphery formed with at least a portion thereof having a flange 77. Periphery 81 and flange 77 of coin housing 71 each have predetermined outer dimensions. Display board 83 is shown having cavity 85 formed therein through display board 83. Cavity 85 has a periphery 87 formed to accommodate the periphery 81 of coin housing 71 to receive and secure coin housing 71 therein. Flange 77 of coin housing 71 is further formed so as to prevent coin housing 71 from being pushed fully through cavity 85 of display board 83. Another benefit of flange 77 is that it acts to seat and align coin housing 71 relative to display board 83. Periphery 81 of coin housing 71 is formed with predetermined outer dimensions. At least a small portion of periphery 87of cavity 85 has a step 89 formed so as to also prevent coin housing 71 from being pushed fully through cavity 85 of display board 83. Another benefit of step 89 is that it also acts to seat and align coin housing 71 relative to display board 83. In this embodiment of the present invention shown, periphery 81 and periphery 87 are each formed so as to frictionally secure coin housing 71 within cavity 85 of display board 83. Periphery 81 of coin housing 71 may be slightly tapered so as to facilitate installation of coin housing 71 into cavity 85. Other embodiments of the present invention may include a device wherein periphery 81 and periphery 87 are each formed with interlocking means so as to materially secure coin housing 71 within cavity 85 of display board 83. For example, periphery 81 of coin housing 71 may have a protrusion or protrusions formed to interlock with a corresponding cavity or corresponding cavities located on periphery 87 of cavity 85. The present invention device shown accommodates one coin, however, two or more coins, or a group of coins may be displayed and preserved using additional coin housings and display board cavities. This novel configuration of the present invention device achieves all the objectives set forth earlier herein including the long term display and preservation of a coin, or a group of coins.

Referring now to FIGS. 3, 4 and 5 together, it can be seen that each embodiment of the present invention device involves a coin housing which has a flange, and/or, a display board which has a stepped cavity. The flange may extend partially or fully around the periphery of the coin housing, and, the cavity step may extend partially or fully around the periphery of the cavity. A coin housing may be frictionally secured within a display board cavity, and/or, materially secured with in a display board cavity. Each embodiment of the present invention device provides for the installation of a coin without the need to press upon the obverse or reverse surfaces of the coin. The present invention device does not include sliding panels which could rub against and damage a coin or coins. The present invention coin housing is preferably made from an inert, synthetic material which will not chemically affect the housed coin. The present invention device could be used to display and preserve just one coin, or more than one coin for example, a series of common denomination coins.

When considering the present invention coin display and preservation device, simplicity and obviousness should not be confused or considered the same. The novelty and complexity of the present invention should be measured with full consideration of the many interrelated objectives set forth herein.

Upon reading and understanding the specification of the present invention described above, modifications and alterations will become apparent to those skilled in the art. It is intended that all such modifications and alterations be included insofar as they come within the scope of the patent as claimed or the equivalence thereof.

Having thus described the invention, the following is claimed:

1. A device for the display and preservation of a coin, said device comprising,
a.) a coin housing comprising at least two, substantially transparent interconnecting members formed to house said coin therein with a substantially air-tight encapsulation, said coin housing having a periphery formed with at least a portion thereof having a flange, said periphery having predetermined outer dimensions; and,
b.) a display board having a cavity formed therein, said cavity being formed through said display board and having a periphery formed to accommodate the periphery of said coin housing to receive and secure said housing therein, said coin housing flange further being formed so as to prevent said coin housing from being pushed fully through said cavity of said display board.

2. A device of claim 1, wherein the periphery of said coin housing and the periphery of said cavity are each formed so as to frictionally secure said coin housing within said cavity.

3. A device of claim 1, wherein the periphery of said coin housing and the periphery of said cavity are each formed with interlocking means, so as to materially secure said coin housing within said cavity.

4. A device of claim 1, wherein the entire periphery of said coin housing is formed having a flange.

5. A device of claim 1 for at least two coins, wherein device comprises at least two coin housings and at least two cavities formed in at least one display board.

6. A device of claim 5, wherein the periphery of each said coin housing and the periphery of each said cavity is formed so as to frictionally secure each said coin housing within each said cavity.

7. A device of claim 5, wherein the periphery of each said coin housing and the periphery of each said cavity is formed with interlocking means, so as to materially secure each said coin housing within each said cavity.

8. A device of claim 1 for a group of coins, wherein said device comprises a group of coin housings and a group of cavities formed in at least one display board.

9. A device of claim 8, wherein the periphery of each said coin housing and the periphery of each said cavity is formed so as to frictionally secure each said coin housing within each said cavity.

10. A device of claim 8, wherein the periphery of each said coin housing and the periphery of each said cavity is formed with interlocking means, so as to materially secure each said coin housing within each said cavity.

11. A display and preservation device for a coin, said device comprising,
a.) a coin housing comprising at least two, substantially transparent interconnecting members formed to house said coin therein with a substantially air-tight encapsulation, said coin housing having a periphery formed with predetermined outer dimensions; and,
b.) a display board having a cavity formed therein, said cavity being formed through said display board and having a periphery formed to accommodate the periphery of said coin housing so as to receive and secure said coin housing therein, and, at least a small portion of the periphery of said cavity having a step formed, so as to prevent said coin housing from being pushed fully through said cavity of said display board.

12. A device of claim 11, wherein the periphery of said coin housing and the periphery of said cavity are each formed so as to frictionally secure said coin housing within said cavity.

13. A device of claim 11, wherein the periphery of said coin housing and the periphery of said cavity are each formed with interlocking means, so as to materially secure said coin housing within said cavity.

14. A device of claim 11, wherein the entire periphery of said cavity is formed having a step.

15. A device of claim 11 for at least two coins, wherein said device comprises at least two coin housings and at least two cavities formed in at least one display board.

16. A device of claim 15, wherein the periphery of each said coin housing and the periphery of each said cavity is formed so as to frictionally secure each said coin housing within each said cavity.

17. A device of claim 15, wherein the periphery of each said coin housing and the periphery of each said cavity is formed with interlocking means, so as to materially secure each said coin housing within each said cavity.

18. A device of claim 11 for a group of coins, wherein said device comprises a group of coin housings and a group of cavities formed in at least one display board.

19. A device of claim 18, wherein the periphery of each said coin housing and the periphery of each said cavity is formed so as to frictionally secure each said coin housing within each said cavity.

20. A device of claim 18, wherein the periphery of each said coin housing and the periphery of each said cavity is formed with interlocking means, so as to materially secure each said coin housing within each said cavity.

21. A device for the display and preservation of a coin, said device comprising,
a.) a coin housing comprising at least two, substantially transparent interconnecting members formed to house said coin therein with a substantially air-tight encapsulation, said coin housing having a periphery formed with at least a portion thereof having a flange, said periphery having predetermined outer dimensions; and,
b.) a display board having a cavity formed therein, said cavity being formed through said display board and having a periphery formed to accommodate the periphery of said coin housing so as to receive and secure said coin housing therein, said coin housing flange further being formed so as to prevent said coin housing from being pushed fully through said cavity of said display board, and, at least a small portion of the cavity of said display board having a step formed, so as to further prevent said coin housing from being pushed fully through said cavity of said display board.

22. A device of claim 21, wherein the periphery of said coin housing and the periphery of said cavity are each formed so as to frictionally secure said coin housing within said cavity.

23. A device of claim 21, wherein the periphery of said coin housing and the periphery of said cavity are each formed with interlocking means, so as to materially secure said coin housing within said cavity.

24. A device of claim 21, wherein the entire periphery of said coin housing is formed having a flange.

25. A device of claim 21, wherein the entire periphery of said cavity is formed having a step.

26. A device of claim 21, wherein the entire periphery of said coin housing is formed having a flange, and, the entire periphery of said cavity is formed having a step.

27. A device of claim 21 for at least two coins, wherein said device comprises at least two coin housings and at least two cavities formed in at least one display board.

28. A device of claim 27, wherein the periphery of each said coin housing and the periphery of each said cavity is formed so as to frictionally secure each said coin housing within each said cavity.

29. A device of claim 27, wherein the periphery of each said coin housing and the periphery of each said cavity is formed with interlocking means, so as to materially secure each said coin housing within each said cavity.

30. A device of claim 21 for a group of coins, wherein said device comprises a group of coin housings and a group of cavities formed in at least one display board.

31. A device of claim 30, wherein the periphery of each said coin housing and the periphery of each said cavity is formed so as to frictionally secure each said coin housing within each said cavity.

32. A device of claim 30, wherein the periphery of each said coin housing and the periphery of each said cavity is formed with interlocking means, so as to materially secure each said coin housing within each said cavity.
